(19) United States
(12) Patent Application Publication
(10) Pub. No.: US 2009/0078502 A1
(43) Pub. Date: Mar. 26, 2009

(54) MOVABLE WORK PLATFORM

(76) Inventor: Frank Knurr, (US)

Correspondence Address: CHRISTINE JOHNSON ESQ., 151 Trenton Rd., Fairless Hills, PA, 19030, US

(21) Appl. No.: 12/234,863

(22) Filed: Sep. 22, 2008

(30) Foreign Application Priority Data
Sep. 22, 2007 (DE) 102007045353.3

(51) Int. Cl. E04G 1/18; B66F 11/04; E04G 1/22

(52) U.S. Cl. 182/13; 182/148; 182/223; 182/69.6; 182/113

(57) ABSTRACT

A working platform (1) for aircraft maintenance has two chassis (3a, 3b), a working stage (5) and two height-adjustable support means (4a, 4b) connecting the working stage (5) to the chassis (3a, 3b). The working surface of the working stage (5) is assembled from at least two mutually separable segments (_b 5a, 5b, . . . ), wherein a first (5a) of the segments is supported by the first chassis (3a) and the first height-adjustable support means (4a) and a second (5b) of the segments is supported by the second chassis (3a) and the second height adjustable support means (4b).

### CROSS REFERENCE TO RELATED APPLICATIONS

This application claims priority to German patent application Serial No. 10 2007 045 353.3 to the same inventor filed in the German Patent Office Sep. 22, 2007.

### FIELD OF THE INVENTION

The present invention relates to a movable working platform which is suitable, in particular, for maintenance work on aircraft.

### BACKGROUND OF THE INVENTION

A height-adjustable working platform is known, for example, from DE 103 35 687 A1. This working platform comprises a chassis, a working stage and height-adjustable support means, which connect the working stage to the chassis, in the form of three telescopic masts which are arranged mutually crossing.

A working platform of this type is suitable for performing maintenance work on the external surfaces of an aircraft, beneath which the aircraft has no projections. Surfaces such as a side wall of the aircraft fuselage above the wings or the windscreens of the cockpit cannot be reached satisfactorily with this conventional working platform.

In practice, this leads thereto that an aircraft on the outer skin of which maintenance operations must be carried out is driven with its nose into a fixed dock and mobile dock elements are assembled along the fuselage in order to make the outer skin fully accessible. This procedure takes up to 300 to 600 working hours, so that it is extremely time-intensive and costly. Since the fixed docks which permit access to the cockpit windscreens are each specific to one particular aircraft type, it is difficult to service different aircraft types in the same hangar. If different types of fixed dock are available at a maintenance station, only one of them can be used at any one time and if each service station has only one type of dock, then very large hangar spaces are necessary for the maintenance of different aircraft types.

### SUMMARY OF THE INVENTION

It is an object of the invention to provide a mobile working platform which enables easy and reliable access even to parts of an aircraft surface that are situated above a projection of the aircraft outer skin, in particular to the cockpit windscreens above the tip of the nose of an aircraft.

### DETAILED DESCRIPTION

This aim is achieved in that in a working platform comprising a first chassis, a working stage and first height-adjustable support means connecting the working stage to the chassis, the working surface of the working stage is assembled from two mutually separable segments, wherein a first of the segments is supported by the first chassis and the first height-adjustable support means and a second of the segments is supported by a second chassis and a second height-adjustable support means. In that the projection, that is, the tip of the nose can engage in an intermediate space between the two support means, a working platform of this type can be moved over the tip of the nose directly to the cockpit windscreens.

In order to increase the distance between the support means, preferably at least a third segment can be placed between the first and the second segment of the working stage. The at least one third segment can suitably be supported by at least two longitudinal supports which, in turn, are each supported on the two support means.

The third segment can be removable from the working platform when not in use.

In order to optimise access to the aircraft outer skin, the third segment can have a recess with an edge shape adapted to the contour of an aircraft nose. Therefore, of the various segments of the working stage, only the third one has to be specifically changed for a particular aircraft model if different aircraft models are to be serviced with the working platform according to the invention.

In order to improve the stability of the working stage, a fourth segment can be provided, which connects the first and the second segment. This fourth segment can suitably also serve to support the third segment.

According to an alternative embodiment, the third segment can be telescoped between a position substantially overlapping the first segment and a position substantially free from overlap with the first segment.

According to a further embodiment, provided on the first and the second segment of the working stage are a first and a second telescopic extension, each of which can be coupled to the respective other one of the two segments, wherein each telescopic extension comprises at least one proximal and one distal displaceable rail and each proximal rail is connected to a telescopically extensible segment of the working stage.

For the safety of the service personnel, it is also suitable for the segments to have a telescopically extensible railing.

Each chassis of the working platform preferably has its own motor. This enables each of the two units comprising a chassis, support means and a working stage segment of the working platform according to the invention also to be used individually as a complete self-driven working platform. In order to move the two units of the working platform according to the invention in a coordinated manner, the motors of the two chassis are preferably controllable synchronously by means of a common control device.

In order to be able to use the two units of the working stage according to the invention independently of one another, each chassis preferably has its own control device which is configured to operate as the common control device.

In order to be able to work on inclined surfaces of the aircraft outer skin, such as, for example, a wing surface, it is suitable that the first and second support means can be adjusted to different heights.

Further features and advantages of the invention are given in the following description of exemplary embodiments, making reference to the drawings, in which:

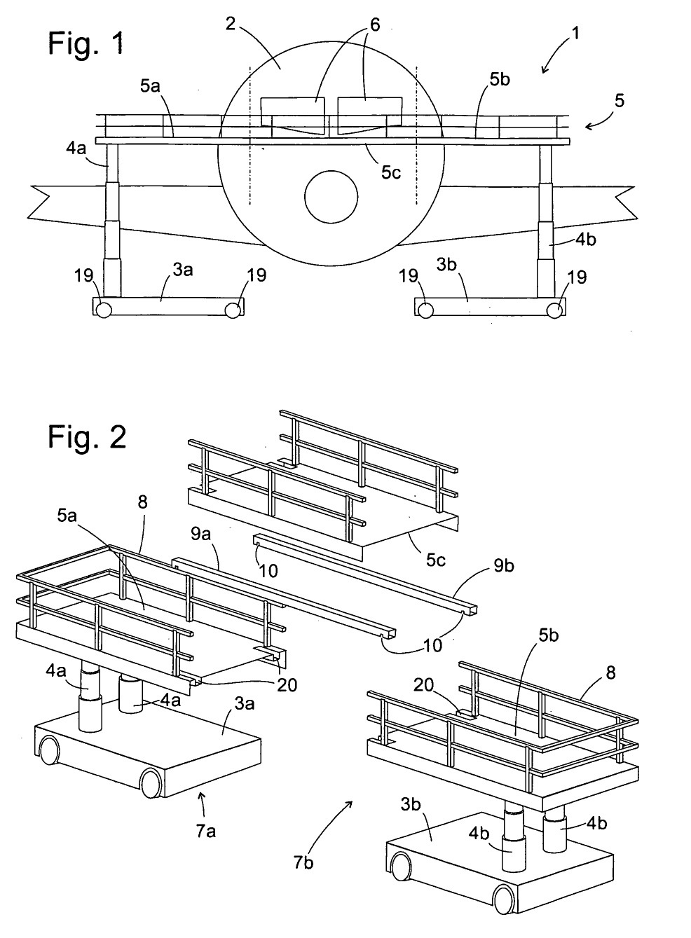

FIG. 1 shows a schematic front view of a working platform according to the invention, placed in front of the nose of an aircraft;

FIG. 2 shows a disassembled perspective view of parts of the working platform according to the invention;

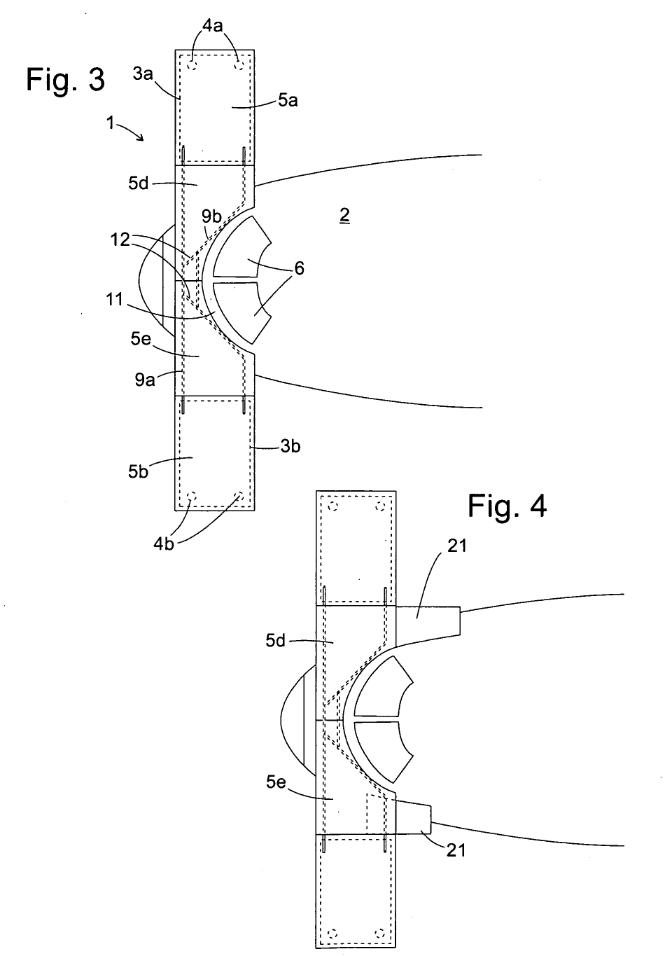

FIG. 3 shows a plan view of a further development of the working platform of FIG. 2;

FIG. 4 shows a first derivation of the working platform of FIG. 3;

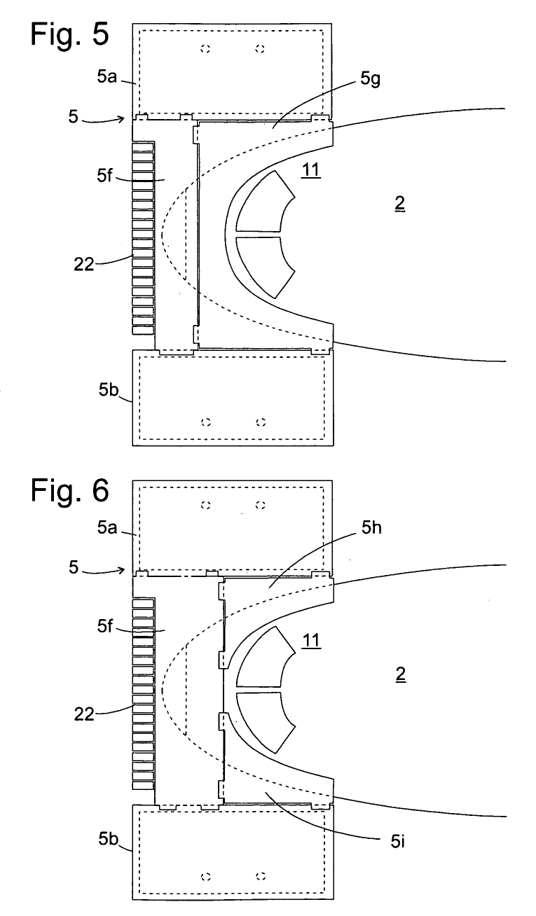

FIG. 5 shows a second derivation of the working platform of FIG. 3;

FIG. 6 shows a third derivation of the working platform of FIG. 3;

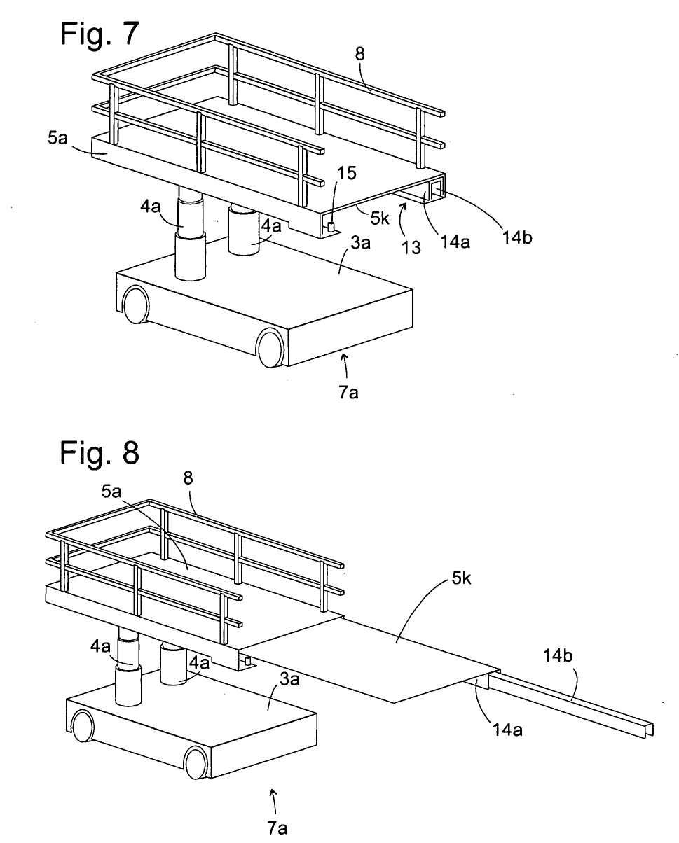

FIG. 7 shows a perspective view of a part of a working platform according to a second embodiment of the invention in a telescopically collapsed configuration;

FIG. 8 shows a perspective view of the part in an expanded configuration; and

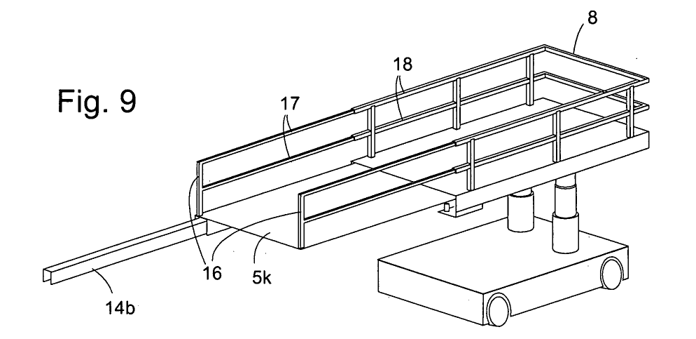

FIG. 9 shows a variant of the part of FIG. 8.

FIG. 1 shows a front view of a working platform 1 according to the invention, placed before an aircraft 2 to be serviced. The working platform 1 comprises two motorised chassis 3a, 3b with support means 4a, 4b mounted thereon, in the form of vertically oriented telescopically extensible hydraulic cylinders and a working stage 5 assembled from segments 5a, 5b, 5c and supported by the support means 4a, 4b. The chassis 3a, 3b move on MECANUM rollers 19. These rollers 19, which are per se known, comprise two wheel disks which are rotatably drivable about a main drive axis, between which a plurality of roller bodies are arranged which are freely rotatable about axes each skewed relative to the main rotation axis. Only the roller bodies have contact with the ground. These rollers enable various movement modes. In that all the wheel disks rotate in the same sense about the main rotation axis, the chassis moves forwards or backwards, perpendicularly to the main rotation axis. In order to move to the right or the left, mutually adjacent rollers are rotatingly driven in opposing senses. If the right and left rollers are driven in mutually opposing senses, the chassis rotates on the spot.

The dimensions of segments 5a, 5b approximately match those of the respective chassis 3a, 3b situated thereunder; the segment 5c situated between them is anchored in form-fitting manner to, and supported on, both the adjacent segments 5a, 5b. Formed beneath the working stage 5 is a broad intermediate space into which the tip of the nose of the aircraft 2 can project, so that the working stage 5 can be moved beyond the tip of the nose to the immediate vicinity of the cockpit windscreens 6.

The support means 4a, 4b are each placed off-centre on the chassis in order to make the intermediate space below the working stage 5 broad. As can readily be seen, however, the support means 4 could also be arranged centrally on the respective chassis 3a, 3b, or a scissor mechanism of the type known from DE 103 35 687 A1 could be used, since the width of the intermediate space required to pass over the tip of the nose can be readily provided in that the central segment 5c is made wide enough or a plurality of central segments 5c are placed adjacent to one another between the outer segments 5a, 5b.

FIG. 2 shows the structure of the working stage 1 of FIG. 1 in more detail disassembled and in a perspective view. The chassis 3a, the support means 4a and the segment 5a and the chassis 3b, the support means 4b and the segment 5b each form an autonomous vehicle 7a or 7b, which can function alone as a working platform. Suitably, for this purpose, the railing 8 shown in FIG. 2 on only three edges of the segments 5a, 5b is augmented by an auxiliary railing (not shown) on the respective unprotected edge of the segments 5a, 5b in FIG. 2.

In order to assemble the two vehicles 7a, 7b into the working platform 1, longitudinal supports 9a, 9b which couple the segments 5a, 5b to one another in form-fitting manner are inserted into depressions 20 of each segment 5a, 5b. The form-fitting coupling can be achieved, for example, with the aid of recesses 10 in the longitudinal supports 9a, 9b in each of which a rib (not shown in FIG. 2) of the segment 5a, 5b engages; any other type of form-fitting can also be suitable. Subsequently, the central segment 5c is placed on the assembled longitudinal supports 9 in order to close the gap between the segments 5a, 5b and to produce a continuous, level working stage 5.

Provided the vehicles 7a, 7b are not coupled to one another, their working platform segments 5a, 5b must be locked in the horizontal position in order to enable safe working. If the segments 5a, 5b, 5c are coupled into a rigid working stage 5, this locking can be released in order to enable height adjustment of the support means 4a and 4b independently of one another. Thus a position of the working stage 5 which deviates from the horizontal, for example, parallel to the underside of a wing of the aircraft 2, can be set if the working platform 1 is to be used for working on the wing.

Since each vehicle 7a, 7b can be used alone as a working platform, it also has a user interface, for example, in the form of an operating console on the chassis 3 or a radio control system and a control device (not shown) for converting commands input via the operating console into commands to control the individual motors of the rollers 19. In the coupled state, the motors of both vehicles 3a, 3b must operate in coordinated manner in order to enable translation or rotation movements of the working platform 1. The control devices of the chassis 3a, 3b are configured to detect the coupled condition of the vehicles 7a, 7b by means, for example, of the presence or absence of the longitudinal support 9a or 9b in one of the depressions 20 and to take account thereof when the user commands are converted into commands for the motors of the chassis 3a or 3b.

FIG. 3 shows a plan view of a derived embodiment of the working platform with a working stage assembled from four segments 5a, 5b, 5d, 5e. The segments 5a, 5b are the same as shown in FIGS. 1 and 2. The longitudinal support 9a is elongated in order to support the two central segments 5d, 5e, and the longitudinal support 9b has an angled course round a recess 11 in the two central segments 5d, 5e. Extensions 12 of the longitudinal support 9b rest on the longitudinal support 9a. Both the longitudinal supports 9a, 9b together bear the two central segments 5d, 5e.

The contour of the recess 11 is adapted to the form of the nose of an aircraft and follows the outline of an aircraft nose at a height just below the cockpit windscreens 6. The working platform 1 can therefore be moved to the immediate vicinity of the cockpit windscreens 6 over the nose of the aircraft and the windscreens are then readily accessible along the edges of the recess 11.

FIG. 4 shows a development of the working platform 1 of FIG. 3 wherein the central segments 5d, 5e each carry movable extension segments 21. The extension segments 21 can each be articulated on an edge of the segments 5d, 5e in order to be pivoted out when in use; in the embodiment of FIG. 4, they are stowed under the segments 5d, 5e and can be moved, guided on rails, into the deployment position shown on the extension segment 21 of the segment 5d. The extension segment 21 of the segment 5e is shown in a partially extended position.

In the embodiment of FIG. 5, the segments 5a, 5b are oriented along the fuselage of the aircraft, and a segment 5f supported on them and connecting them in form-fitting manner extends only over part of the length of the segments 5a, 5b. A rectangular segment 5g provided on a longitudinal side with an aircraft-specific recess 11 is supported on the segments 5a, 5b, 5f. The ratio of aircraft-specific segments to the total area of the working stage 5 is smaller here than in the embodiment of FIGS. 3 and 4, so that the costs for adaptation to various aircraft types are smaller.

A height-adjustable stairway 22 coupled to the segment 5f facilitates access to the working stage 5.

In the embodiment of FIG. 6, the ratio of aircraft-specific segments to the total area of the working stage 5 is further reduced in that the segment 5g is replaced by two substantially triangular segments 5h, 5i, each of which is supported on the segment 5f and one of the segments 5a, 5b.

A second embodiment of a vehicle 7a of the working platform is shown in FIG. 7 in a perspective view. The chassis 3a, the support means 4a and the working stage segment 5a are substantially the same as described in relation to FIG. 2. A guide for a telescopic extension 13 extends beneath the segment 5a. The telescopic extension 13 comprises a proximal rail 14a which is directly and displaceably mounted on the segment 5a and a distal rail 14b which is displaceably accommodated in a hollow space in the proximal rail 14a. The rails 14a, 14b are coupled to one another such that the proximal rail 14a follows a displacement of the distal rail 14b at half the velocity. A segment 5k stowed under the segment 5a in the configuration of FIG. 7 is firmly attached to the proximal rail 14a. The segment 5a also carries a locking contour 15 to which the tip of the proximal rail 14a of an identically constructed vehicle can be anchored in form-fitting manner.

FIG. 8 shows the same vehicle as in FIG. 7 with the telescopic extension 13 and the working stage segment 5k in their extended configuration. If the vehicle of FIG. 8 is coupled to a vehicle with the same, but mirror-image, configuration, the segment 5k of the vehicle shown in FIG. 8 is supported on an edge by the proximal rail 14a of the vehicle shown and on the opposing edge by the distal rail of the vehicle which is not shown; accordingly, the distal rail 14b of the vehicle shown supports a telescopically extended working stage segment of the other vehicle. In the coupled condition, the two vehicles thereby form a working platform 1 with an intrinsically rigid four-segment working stage. Whereas in the embodiment of FIG. 2, the distance between the outer segments 5a, 5b is predetermined by the length of the longitudinal supports 9a, 9b, the working stage formed from two vehicles as per FIGS. 7 and 8 can have variable widths, depending on how far the rails 14a, 14b are extended. Due to the coupling of the movement of the rails 14a, 14b to one another, the segments 5k of both the vehicles make contact with one another at all times regardless of whether the rails 14a, 14b are fully or only partially extended. Regardless of its width, the working stage 5 therefore always has a closed surface and is usable reliably.

The embodiments shown in FIGS. 7, 8 and FIGS. 5, 6 can be combined in such a manner that the segments 5k of two vehicles as per FIGS. 7, 8 perform the function of the segment 5f as per FIGS. 5 or 6, of supporting segments with aircraft-specific edge contours.

FIG. 9 shows a view similar to that of FIG. 8 of a derivation of the vehicle shown in FIGS. 7 and 8. The extensible working stage segment 5k is herein provided with a railing which comprises vertical supports 16 on an edge of the segment 5k facing away from the segment 5a and horizontal rails 17 extending from the vertical supports 16, the free ends of said rails engaging in hollow horizontal rails 18 of the railing 8 of the segment 5a. When the segment 5k is inserted, similarly to the representation of FIG. 7, under the segment 5a, the rails are stowed inside the rails 18.

1. Working platform (1) comprising a first chassis (3a), a working stage (5) and first height-adjustable support means (4a) connecting the working stage (5) to the chassis (3a), characterised in that the working surface of the working stage (5) is assembled from at least two mutually separable segments (5a, 5b, . . . ), wherein a first (5a) of the segments is supported by the first chassis (3a) and the first height-adjustable support means (4a) and a second (5b) of the segments is supported by a second chassis (3a) and a second height-adjustable support means (4b).

2. Working platform according to claim 1, characterised in that at least a third segment (5c, 5d, . . . ) is adapted to be placed between the first and the second segment (5a, 5b).

3. Working platform according to claim 2, characterised in that the third segment (5d, 5e, 5g, 5h, 5i) has a recess (11) with an edge shape adapted to the contour of an aircraft nose.

4. Working platform according to claim 3, characterised in that the working stage (5) comprises a fourth segment (5f) which connects the first and the second segment (5a, 5b).

5. Working platform according to claim 4, characterised in that the third segment (5g, 5h, 5i) is supported on the fourth segment (5f).

6. Working platform according to claim 2 characterised by at least two longitudinal supports (9a, 9b; 14a, 14b), each supported on both the support means, said longitudinal supports supporting the third segment (5c, 5d, 5e, 5k).

7. Working platform according to claim 2 characterised in that the third segment (5k) can be telescoped between a position substantially overlapping the first segment (5a) and a position substantially free from overlap with the first segment (5a).

8. Working platform according to claim 2 characterised in that mounted on the first and the second segment (5a, 5b) of the working stage (5) are a first and a second telescopic extension (13), each of which can be coupled to the respective other one of the two segments (5a, 5b), wherein each telescopic extension (13) comprises at least one proximal and one distal displaceable rail (14a, 14b) and each proximal rail (14a) is connected to a telescopically extensible segment (5k) of the working stage (5).

9. Working platform according to claim 7 characterised in that the segments comprise a telescopically extensible railing (8; 16, 17).

10. Working platform according to claim 1 characterised in that each chassis (3a, 3b) has its own motor and both the motors are synchronously controllable by means of a common control device.

11. Working platform according to claim 10, characterised in that each chassis (3a, 3b) has its own control device which is configured to operate as the common control device.

12. Working platform according to claim 1 characterised in that the first and the second support means (4a, 4b) can be adjusted to different heights.
